(19) United States
(12) Patent Application Publication
(10) Pub. No.: US 2025/0348828 A1
(43) Pub. Date: Nov. 13, 2025

(54) SYSTEMS AND METHODS FOR COMPUTER IMPLEMENTED SALES PROFESSIONAL GOAL SETTING, TRACKING, AND MOTIVATION

(71) Applicant: Juliana Castillo, Winter Garden, FL (US)

(72) Inventor: Juliana Castillo, Winter Garden, FL (US)

(21) Appl. No.: 18/633,428

(22) Filed: Apr. 11, 2024

Related U.S. Application Data
(60) Provisional application No. 63/458,581, filed on Apr. 11, 2023.

(51) Int. Cl. G06Q 10/0639

(52) U.S. Cl. CPC G06Q 10/06398

(57) ABSTRACT

Methods, systems and computer readable media for sales professional goal setting, tracking, and motivation, are described.

### RELATED APPLICATION

This application claims the benefit of U.S. Application No. 63/458,581, entitled “SYSTEMS AND METHODS FOR COMPUTER IMPLEMENTED SALES PROFESSIONAL GOAL SETTING, TRACKING, AND MOTIVATION”, filed on Apr. 11, 2023, which is incorporated herein by reference in its entirety.

### TECHNICAL FIELD

Embodiments relate generally to computerized sales systems, and more particularly, to methods, systems and computer readable media for sales professional goal setting, tracking, and motivation.

### BRIEF DESCRIPTION OF THE DRAWINGS

FIG. 1 shows an environment configured for methods, systems and computer readable media for sales professional goal setting, tracking, and motivation in accordance with some implementations.

FIG. 2 is a diagram showing an example user login graphical user interface in accordance with some implementations.

FIG. 3 is a diagram showing an example user sign up graphical user interface in accordance with some implementations.

FIG. 4 is a diagram showing an example password recovery graphical user interface in accordance with some implementations.

FIG. 5 is a diagram showing an example one-time password (OTP) and two-factor authentication graphical user interface in accordance with some implementations.

FIG. 6 is a diagram showing an example splash screen with motivational saying graphical user interface in accordance with some implementations.

FIG. 7 is a diagram showing an example user dashboard graphical user interface in accordance with some implementations.

FIG. 8 is a diagram showing an example camera, scanner, or image capture graphical user interface in accordance with some implementations.

FIG. 9 is a diagram showing an example contract list interface in accordance with some implementations.

FIG. 10 is a diagram showing an example contract information graphical user interface in accordance with some implementations.

FIG. 11 is a diagram showing an example scan information graphical user interface in accordance with some implementations.

FIG. 12 is a diagram showing an example goal setting graphical user interface in accordance with some implementations.

FIG. 13 is a diagram showing an example add quick notes graphical user interface in accordance with some implementations.

FIG. 14 is a diagram showing an example add achievement graphical user interface in accordance with some implementations.

FIG. 15 is a diagram showing an example commission structure graphical user interface in accordance with some implementations.

FIG. 16 is a diagram showing an example commission percentage history graphical user interface in accordance with some implementations.

FIG. 17 is a diagram showing an example edit additional income graphical user interface in accordance with some implementations.

FIG. 18 is a diagram showing an example additional bonus history graphical user interface in accordance with some implementations.

FIG. 19 is a diagram showing an example earnings history graphical user interface in accordance with some implementations.

FIG. 20 is a diagram showing an example earnings history calendar graphical user interface in accordance with some implementations.

FIG. 21 is a diagram showing an example spreadsheet reports graphical user interface in accordance with some implementations.

FIG. 22 is a diagram showing an example filter graphical user interface in accordance with some implementations.

FIG. 23 is a diagram showing an example contract notes graphical user interface in accordance with some implementations.

FIG. 24 is a diagram showing an example contract information graphical user interface in accordance with some implementations.

FIG. 25 is a diagram showing an example guest information graphical user interface in accordance with some implementations.

FIG. 26 is a diagram showing an example app settings graphical user interface in accordance with some implementations.

FIG. 27 is a diagram showing an example contract completion date settings graphical user interface in accordance with some implementations.

FIG. 28 is a diagram showing an example instructional video graphical user interface in accordance with some implementations.

FIG. 29 is a diagram showing an example language setting graphical user interface in accordance with some implementations.

FIG. 30 is a diagram showing an example color theme selection graphical user interface in accordance with some implementations.

FIG. 31 is a diagram showing an example delete account dialog graphical user interface in accordance with some implementations.

FIG. 32 is a diagram showing an example sign out dialog graphical user interface in accordance with some implementations.

FIG. 33 is a diagram showing an example photos and documents gallery graphical user interface in accordance with some implementations.

FIG. 34 is a diagram of an example computing device configured for sales professional goal setting, tracking, and motivation in accordance with at least one implementation.

### DETAILED DESCRIPTION

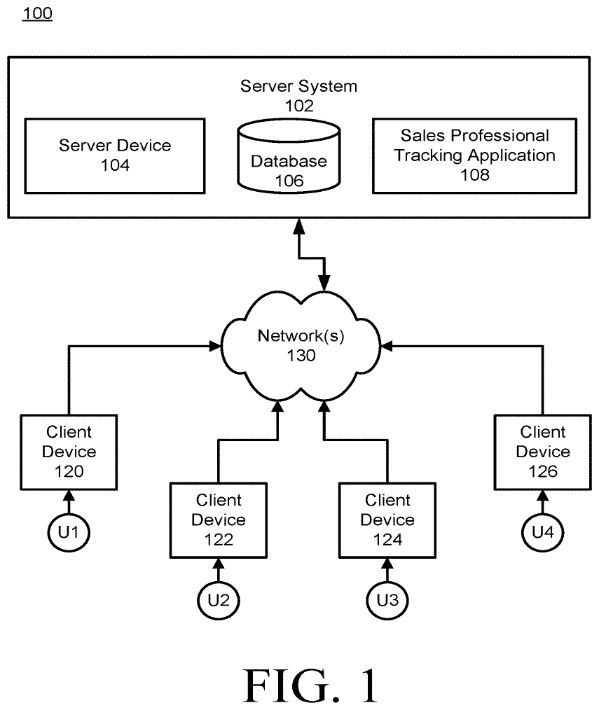

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other data store or data storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMTD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide sales professional goal setting, tracking, and motivation.

Various implementations of features described herein can use any type of system and/or service. Any type of electronic device can make use of features described herein. Some implementations can provide one or more features described herein on client or server devices disconnected from or intermittently connected to computer networks.

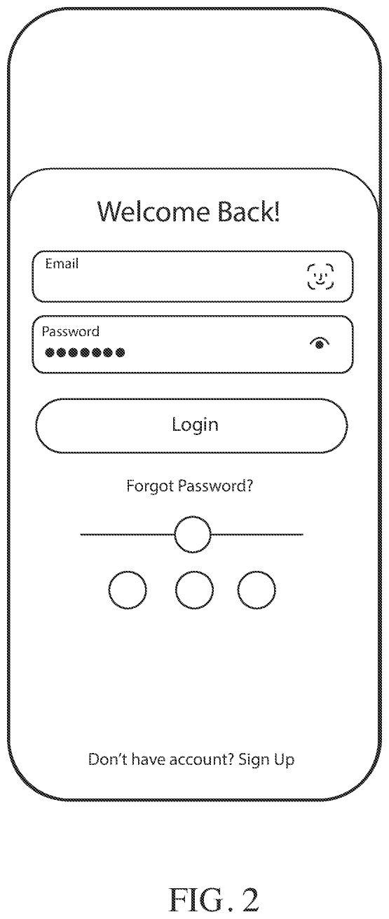

FIG. 2 is a diagram showing an example user login graphical user interface in accordance with some implementations. In particular, FIG. 2 shows an example login graphical user interface (GUI) having an email entry element, a password element, a login button, a forgot password element, one or more single sign on (SSO) elements, and a sign up element.

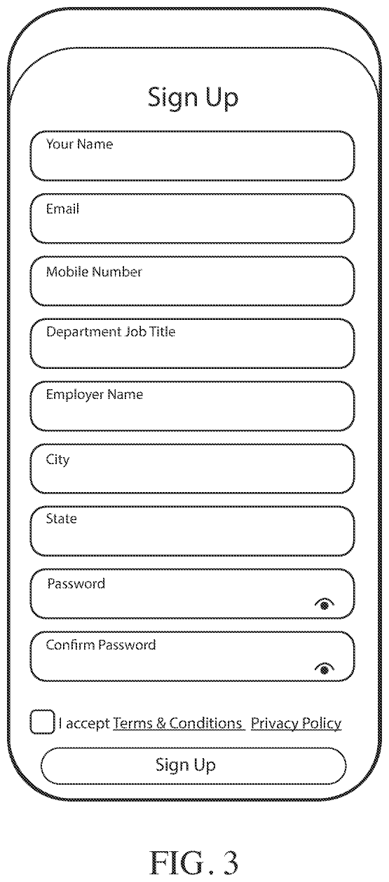

FIG. 3 is a diagram showing an example user sign up graphical user interface (GUI) in accordance with some implementations. The sign up GUI can include elements for entering or editing: name, email, phone number, department job title, employer name, city, state, password, password confirmation, and element to click to accept terms and conditions, and privacy policy.

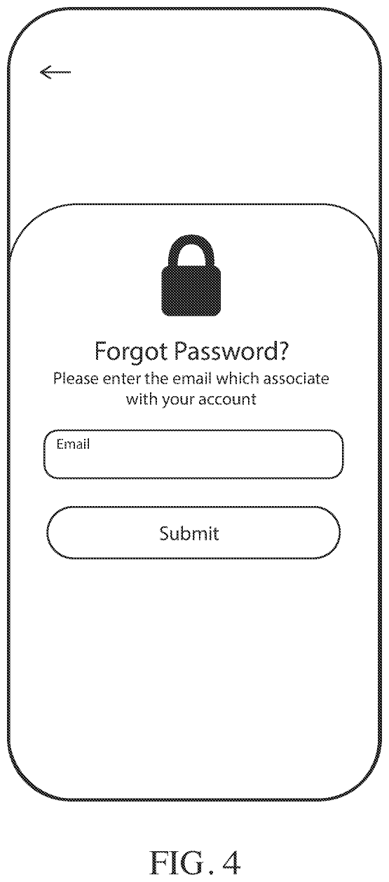

FIG. 4 is a diagram showing an example password recovery GUI having an email element to accept entry of an email and a submit element to process the request for password reset.

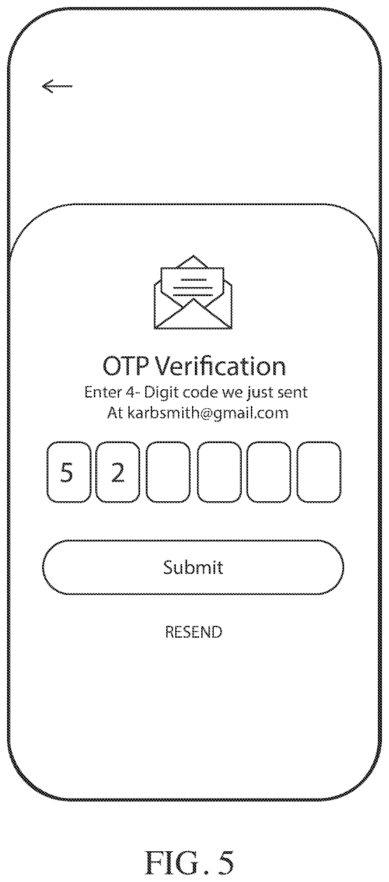

FIG. 5 is a diagram showing an example one-time password (OTP) and two-factor authentication GUI that includes elements to enter the OTP, a submit element, and an element to request resend of an OTP.

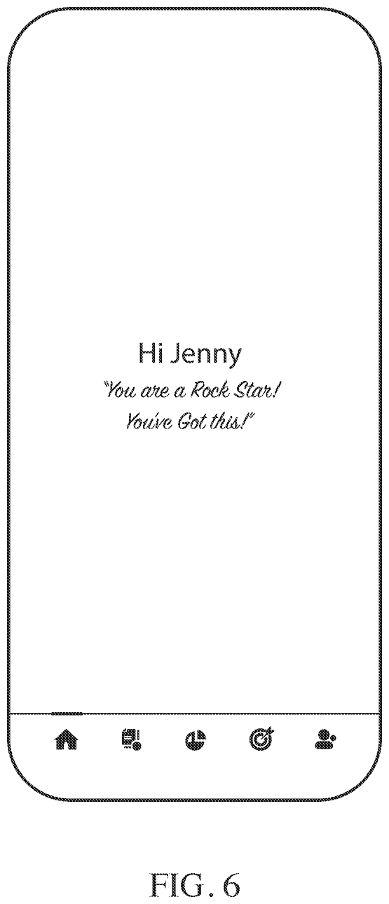

FIG. 6 is a diagram showing an example splash screen with motivational saying GUI that greets a user and shows a motivational quote or saying. The motivational quote or saying can be selected or entered by the user, or can be selected or chosen at random to display a changing quote each time the user logs in.

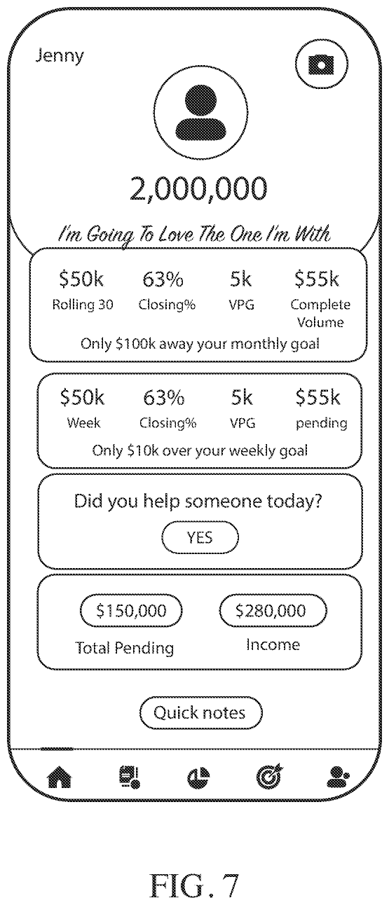

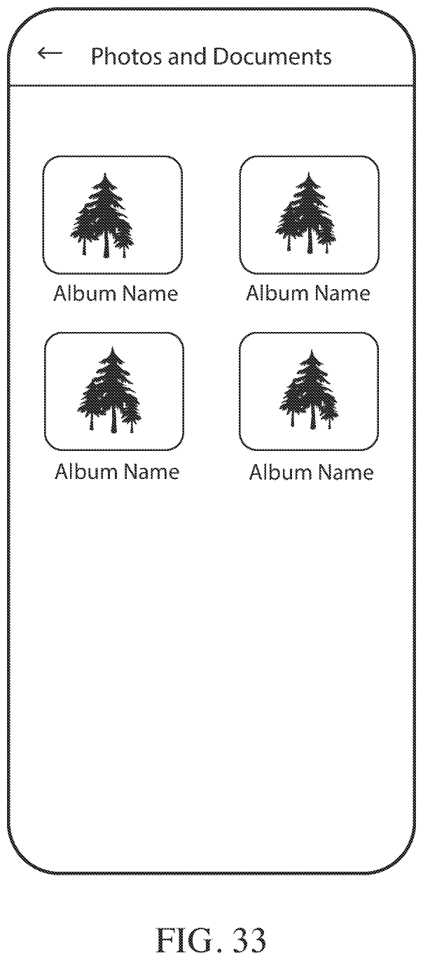

FIG. 7 is a diagram showing an example user dashboard GUI in accordance with some implementations. For FIG. 7 and other screens described below, the concepts of purchase price and sales volume are important. Purchase price is the cost before any discounts. Sales volume is the price after discounts and is used to calculate commissions, etc. The dashboard GUI includes a header with the user's first name, a picture, a camera element (e.g., to take a photo of a profile sheet or other documents such as sales reports, or the like that go to the photo album, see FIG. 33). The dashboard GUI header also includes a total completed sales volume figure and a motivational saying. The dashboard GUI also includes a monthly goal section showing a rolling 30 day sales volume (purchase price less any discounts), a closing percentage (number of guests who purchase divided by number of guests attended seen by user), a VPG (or volume per guest) value that is calculated as originated sales (undiscounted purchase price) divided by number of tours or guests attended to, an ASP (or average sales price) value that is volume sold divided by the number of sales sold for a given (or selected) set time frame, and a completed volume for the month representing monthly sales volume after discounts. The monthly section also indicates how a user is doing for their monthly goal (e.g., in this case the user is only $100 k away from monthly goal), which is not the same as the rolling 30 number, the monthly goal is set in the goal settings page.

The dashboard also includes a weekly section that includes sales for the week (sales before discounts), closing percentage for the week (as described above), VPG (as described above) for the week, ASP (as described above) for the week, and pending sales for the week. The weekly section also includes an indication of how the user is doing for their weekly goal (e.g., in this case the user is $10K over weekly goal). The pending sales are sales that have not met the rescission period. For example, sales may take 10 to 21 days to complete. In the meantime, this volume will be pending. After the user updates the contract status as completed, the volume will then show as completed in the box under the user profile picture and the completed volume for the last 30 days. The sales pending can also open up the pending sales report that permits a user to see which deals may need follow up to complete.

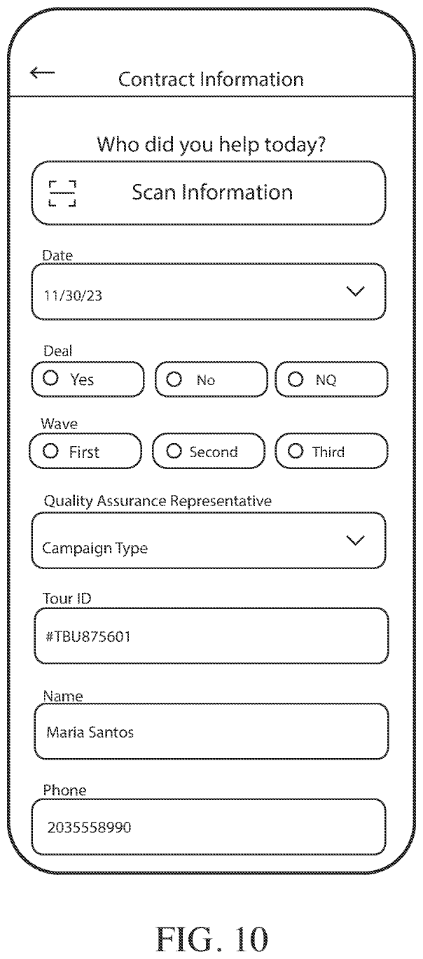

The dashboard also includes an element to enter contracts (or other types of sales presentations or contacts) via the “Did you help someone today?” section, which the user can indicate by selecting the Yes element. When the user selects the Yes element, the user is taken to a GUI, such as that shown in FIG. 10, to enter the contract/tour details.

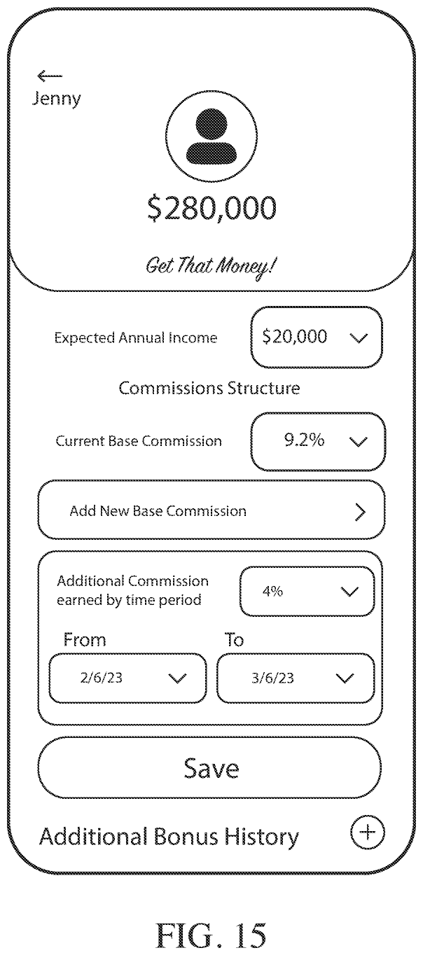

The dashboard also includes a section with total pending contract value and income. The dashboard also includes a quick notes button. The income tab in the dashboard is earned commission that does not take into account the expected annual salary (see FIG. 15).

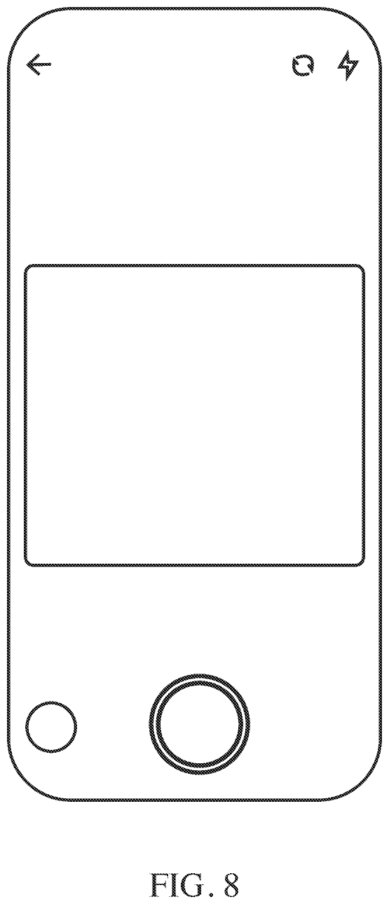

FIG. 8 is a diagram showing an example camera, scanner, or image capture GUI that permits a user to capture images or scan documents such as contracts, sales presentation, or tour information for input into the system.

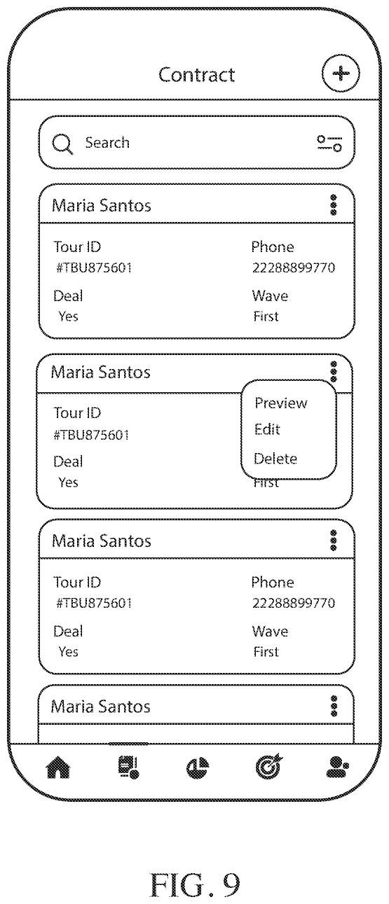

FIG. 9 is a diagram showing an example contract list GUI where a list of contracts are displayed and a user can preview, edit or delete a given contract. The contract information displayed includes a tour ID (or sales presentation ID), phone number, indication of deal made, and indication of wave (or phase of the sales process that the customer is/was in).

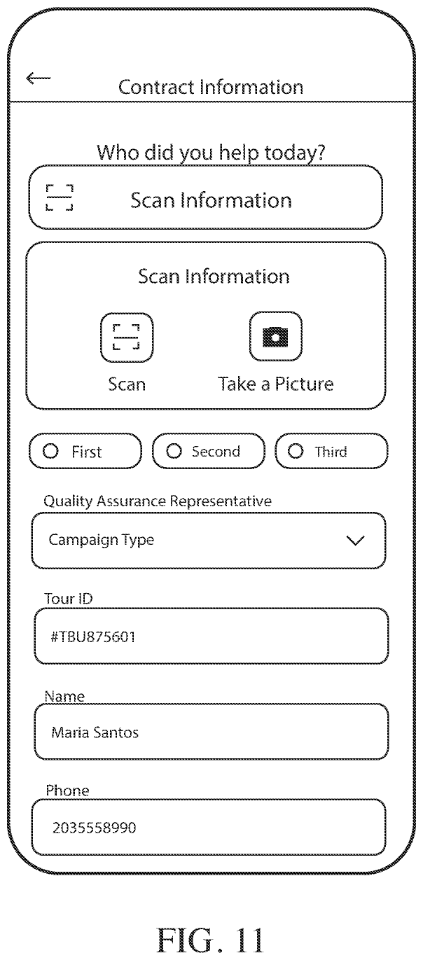

FIG. 10 is a diagram showing an example contract information GUI, which includes an element to scan information (e.g., that can bring up the camera GUI of FIG. 8 or FIG. 11) to capture information from a form and autopopulated the contract information, a date entry element, a deal selection element (e.g., Yes, No, no-qualified), a wave selection element (e.g., first, second, third), a campaign type (e.g., member, renter, other), a tour ID, guest/customer name, and guest/customer phone number. Further, the contract information can also include guest email, contract number, purchase price, commission volume, manager, quality assurance specialist, initial deposit, purchase date, commission rate/base, expected pay date, completion date, user notes, and last payment expected date. The contract information regarding purchase price, commission value, and completion date are used to populate other sales and commission values in the system.

FIG. 11 is a diagram showing an example scan information GUI, which can be activated by selecting the scan information element in FIG. 10 and can give a user a choice of scan or taking a picture of a document or other item.

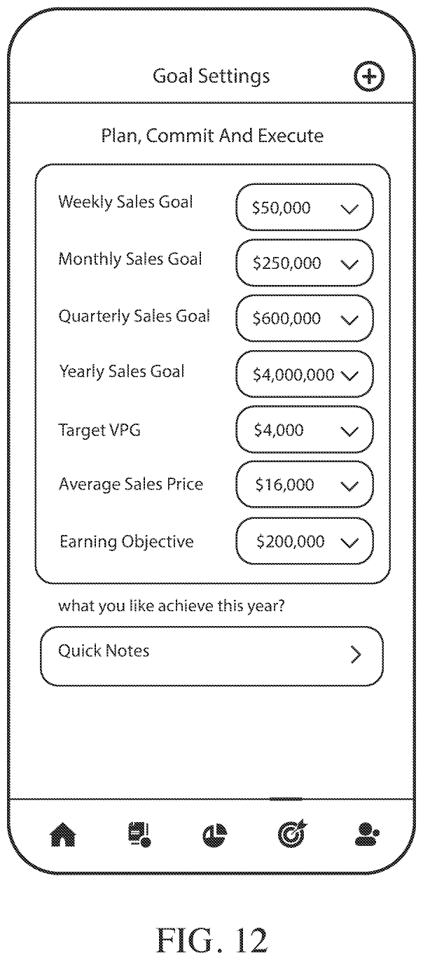

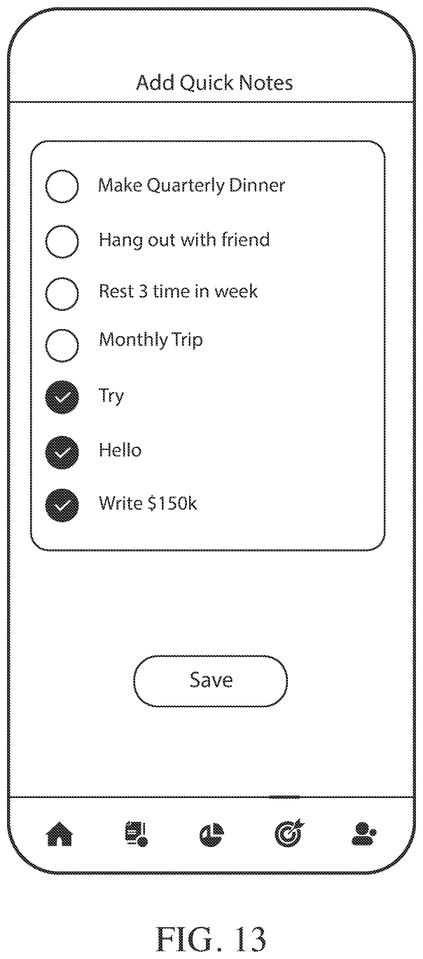

FIG. 12 is a diagram showing an example goal setting GUI, which includes a weekly sales goal, a monthly sales goal, a quarterly sales goal, a yearly sales goal, a target VPG, a target average sales price, and an earning objective. The goal setting GUI also includes a quick note section to enter in notes for goals (e.g., as shown in FIG. 13).

FIG. 13 is a diagram showing an example add goal setting quick notes GUI, which includes one or more notes for goal (e.g., make quarterly dinner) and the goal can be checked off to show it has been completed. The quick notes GUI also includes an element to save the notes list.

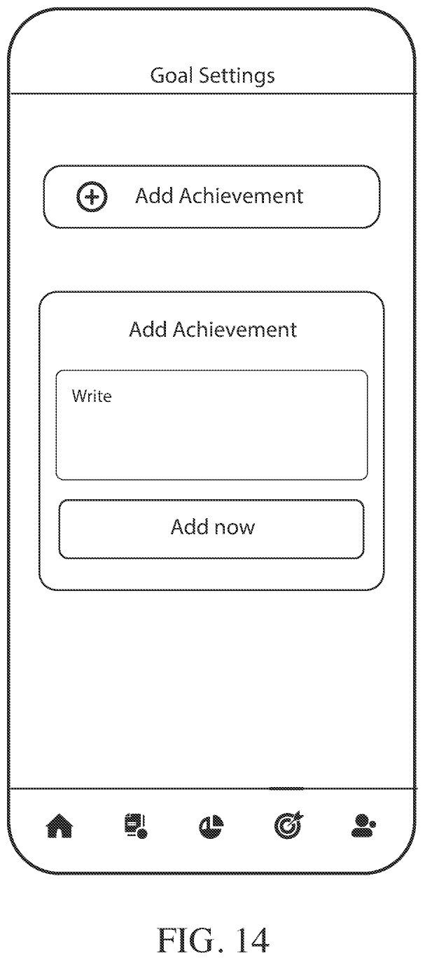

FIG. 14 is a diagram showing an example add achievement GUI, which permits a user to add an achievement to the goals and includes a text entry section and an Add Now button.

FIG. 15 is a diagram showing an example commission structure GUI, which includes a header section with the user's name, picture, commission total, and motivational saying. The commission structure GUI also includes an expected annual income element (e.g., showing income without commission).

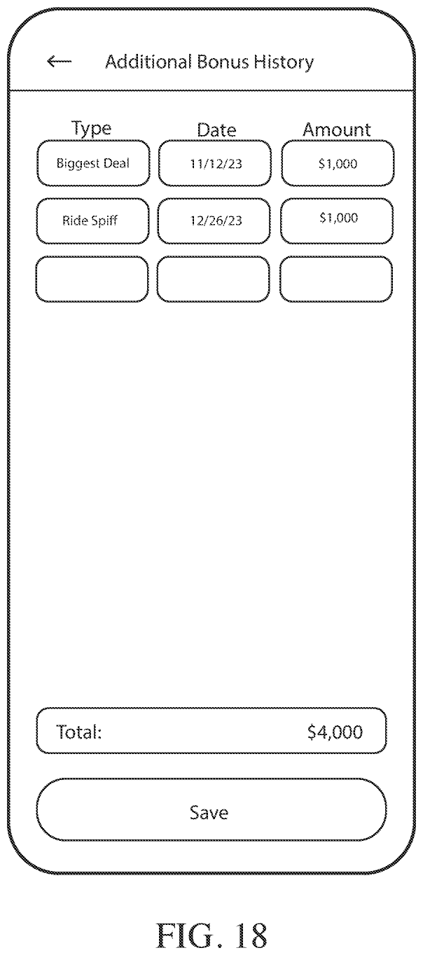

The commission structure GUI includes a commissions structure section with a current base commission element (e.g., showing what the user is normally paid as a percentage of commission volume or sales after discounts), an add new base commission element, additional commission by time period (e.g., to add more commission for a specific time period, such as an additional 4% for the next 20 days), which includes an additional commission percentage and a date range. The commission structure GUI also includes a save button and an additional bonus history selection element which causes an additional bonus history GUI to be displayed (e.g., FIG. 18).

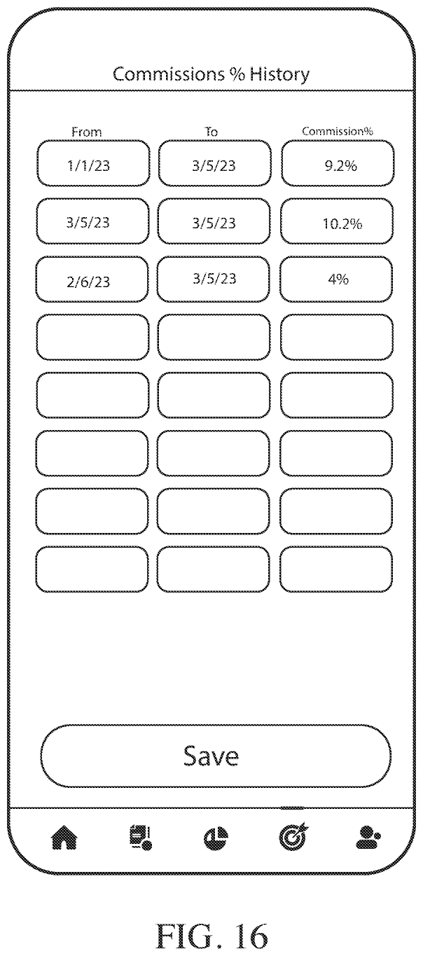

FIG. 16 is a diagram showing an example commission percentage history GUI, which includes a plurality of date ranges and corresponding commission rates. The commission percentage GUI also includes a save button.

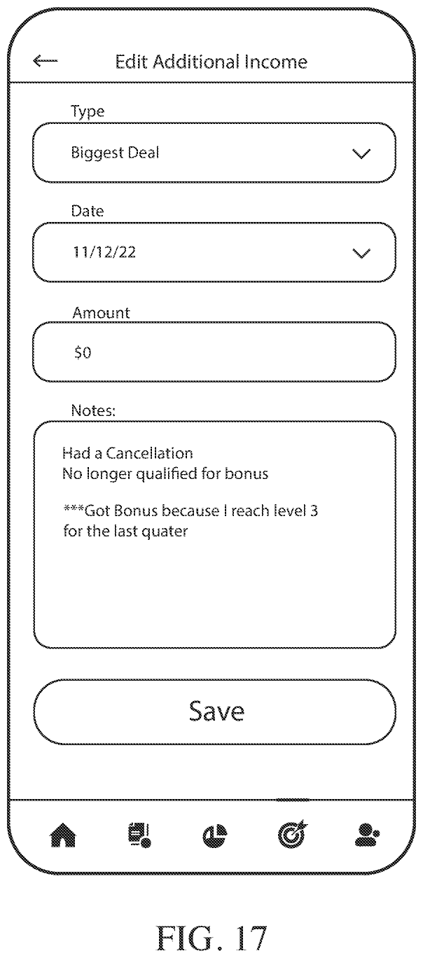

FIG. 17 is a diagram showing an example edit additional income GUI, which includes a type (e.g., biggest deal, etc.), date, amount, a note, and a save button.

FIG. 18 is a diagram showing an example additional bonus history GUI, which includes a type, date, amount, total, and save button.

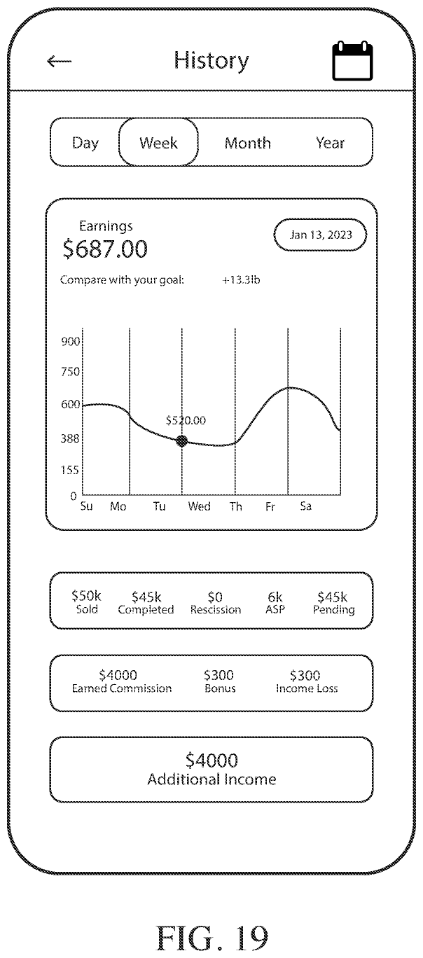

FIG. 19 is a diagram showing an example earnings history GUI, which includes a selection for day, week, month, and year. These elements select the time frame of history a user is viewing. The earnings history GUI also includes an earnings graph section that shows the earnings for a selected period, a date (or date range) of the selected time period, a goal comparison for the given time period (e.g., comparing actual earnings to the earnings set in the goal settings GUI such as FIG. 12), and a graph showing earnings over time (e.g., earnings on a vertical scale and a time period on a horizontal scale). The earnings history GUI also includes a section showing amount sold, amount completed, amount rescinded, ASP, and pending value. The earnings GUI also shows earned commission, bonus, income loss, and additional income.

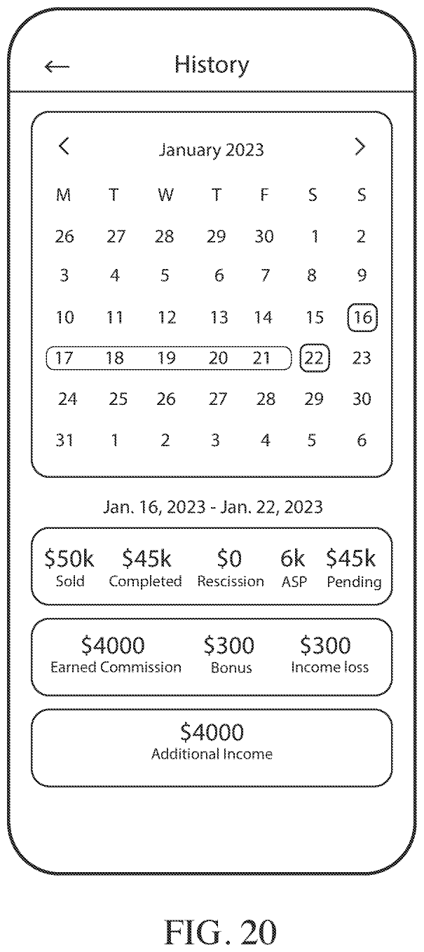

FIG. 20 is a diagram showing an example earnings history calendar GUI, which includes a calendar interface element in place of the graph element of FIG. 19 with the other elements similar to those in FIG. 19.

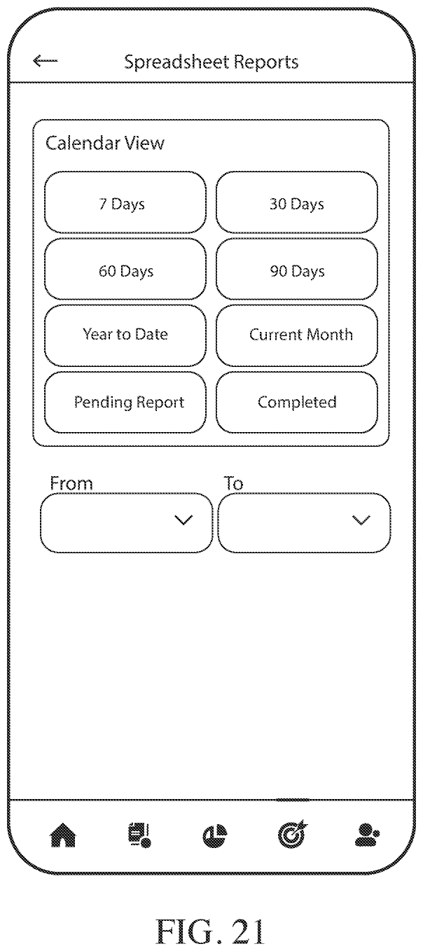

FIG. 21 is a diagram showing an example spreadsheet reports GUI, which includes a calendar view selection for selecting a time period for the report and a customer date range entry pair of elements (e.g., from/to dates).

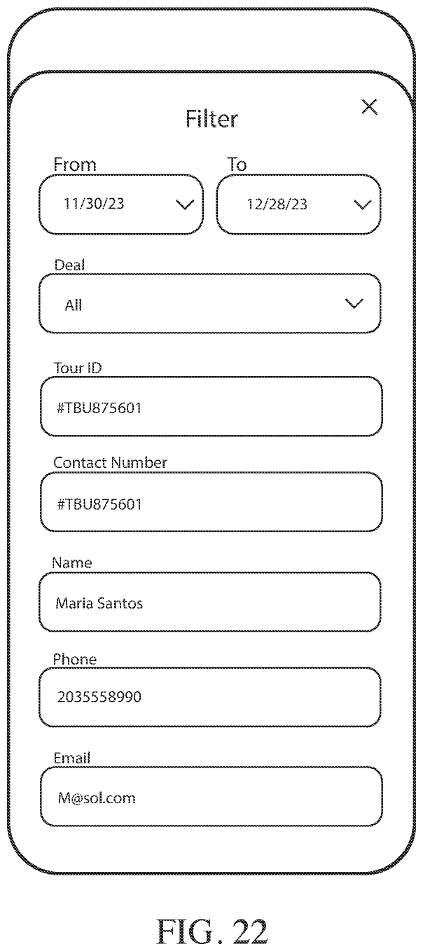

FIG. 22 is a diagram showing an example filter GUI, which includes a date range, a deal type, tour ID, contract number, name, phone, and email elements. These elements can be used to filter the contract list display (e.g., FIG. 9) to help a user locate a particular contract or group of contracts.

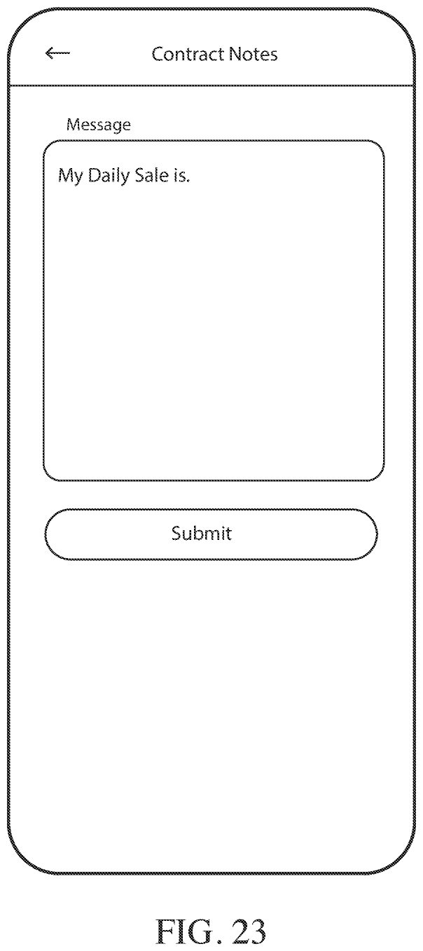

FIG. 23 is a diagram showing an example contract notes GUI that permits a user to enter notes corresponding to a given contract via a text box and submit button.

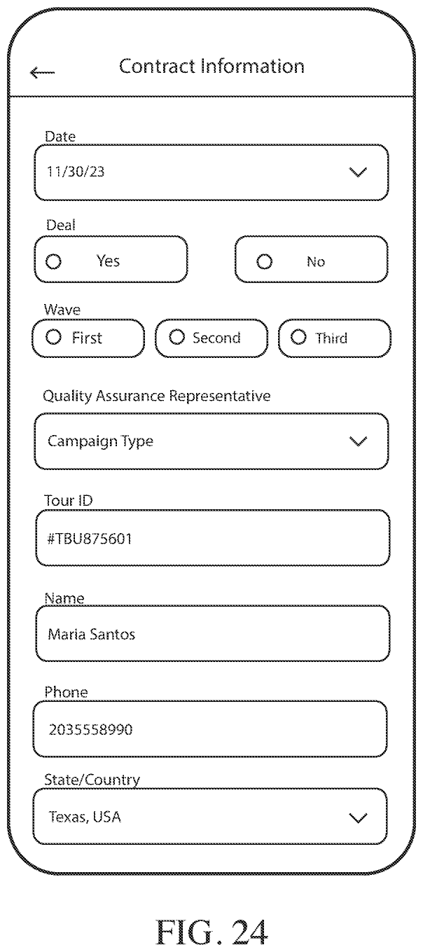

FIG. 24 is a diagram showing an example contract information GUI, which permits a user to view contract information.

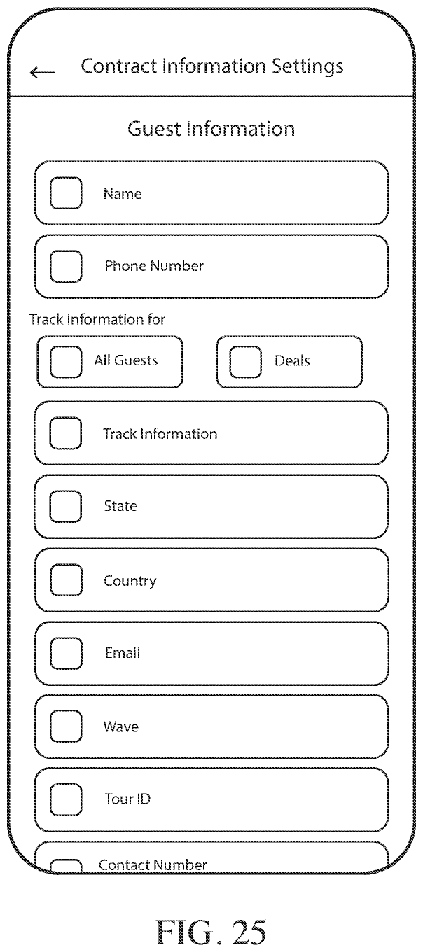

FIG. 25 is a diagram showing an example guest information GUI, which permits a user to configure which information elements are displayed in a contract display (e.g., FIG. 24). The guest information GUI includes elements to select contract information to display including name, phone number, tacking information All Guests and/or Deals, track information, state, country, email, wave, tour ID, and contact number.

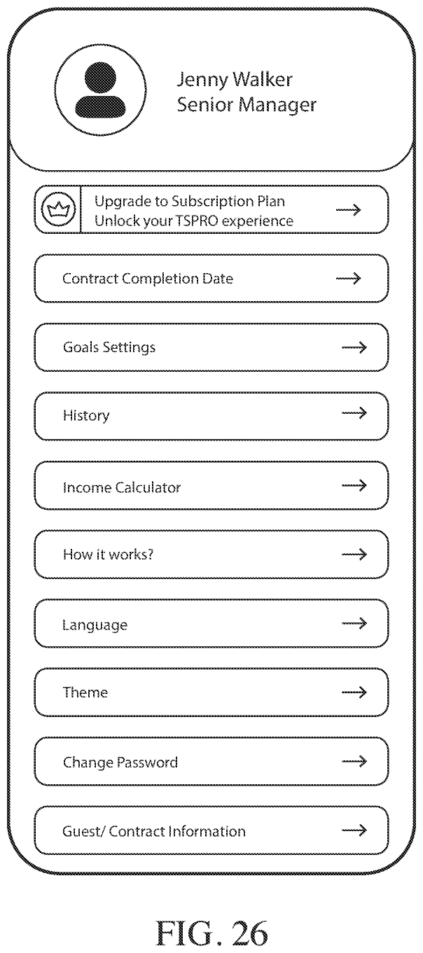

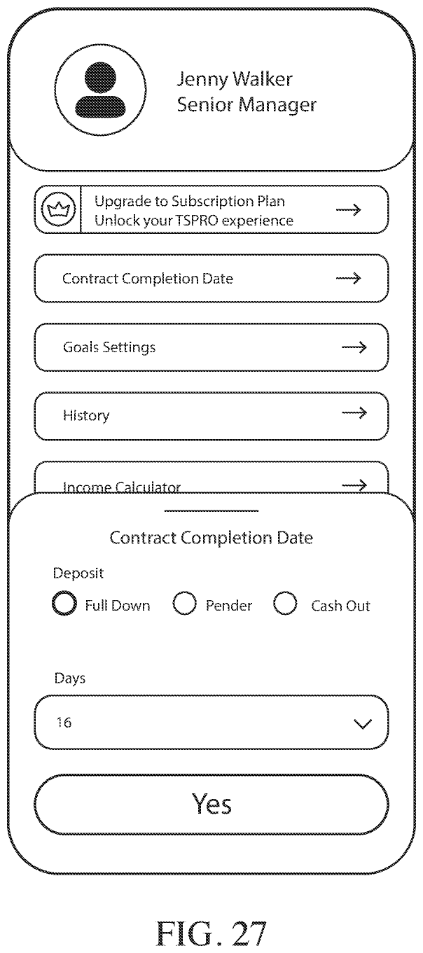

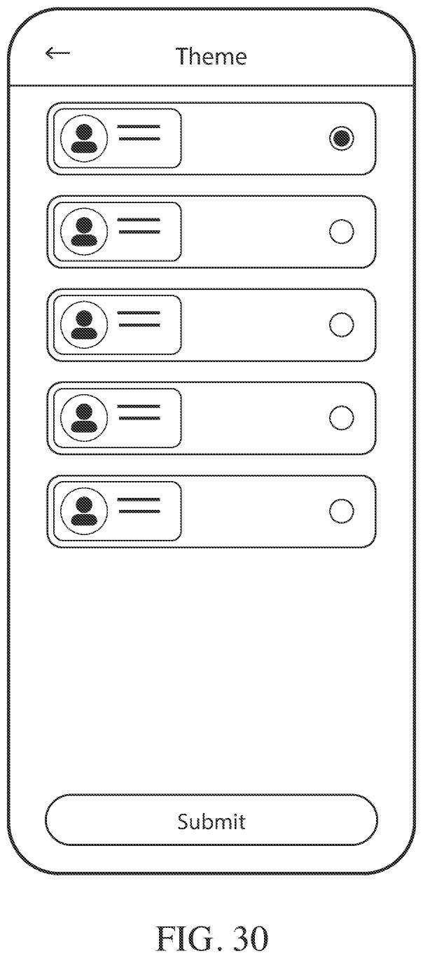

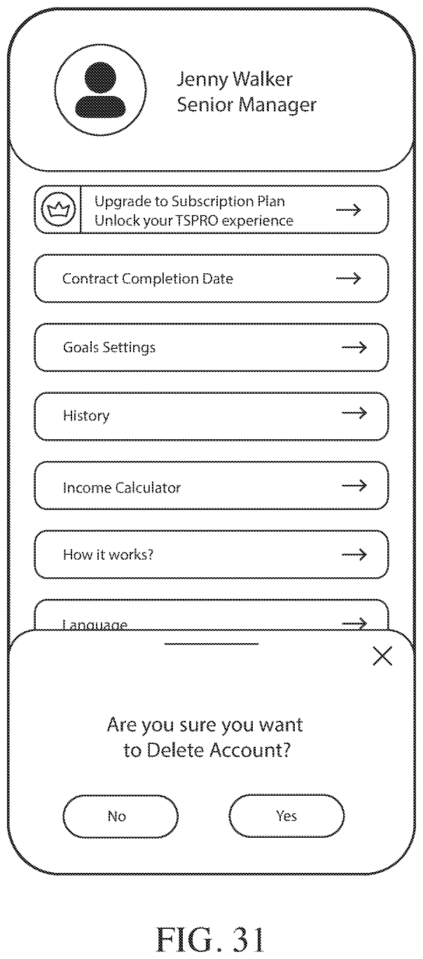

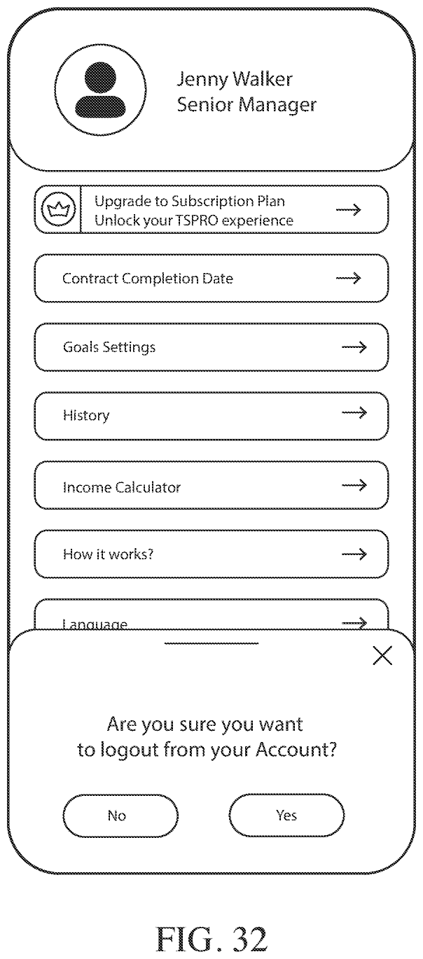

FIG. 26 is a diagram showing an example app settings GUI, which permits a user to configure their mobile application including elements for upgrading to a subscription plan (for users that aren't upgraded yet), contract completion date (e.g., displays FIG. 27), goal settings (e.g., displays FIG. 12), history (e.g., displays FIGS. 19 and/or 20), income calculator, how it works (e.g., FIG. 30), language (e.g., display FIG. 31), theme (e.g., displays FIG. 32), change password, and guest/contract information (e.g., displays FIG. 25).

FIG. 27 is a diagram showing an example contract completion date settings GUI, which includes deposit type (e.g., fulldown, pender, cash out), a number of days selection, and a yes button.

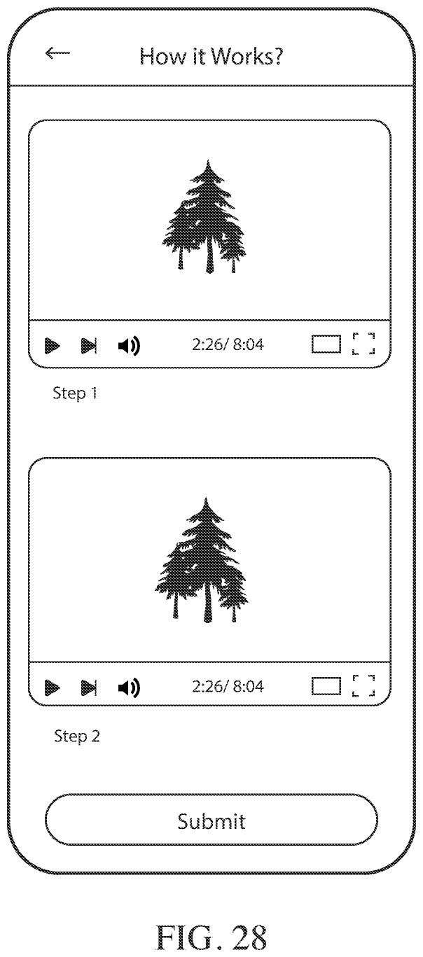

FIG. 28 is a diagram showing an example instructional video GUI, which includes one or more instructional or tutorial videos to assist user in using the application.

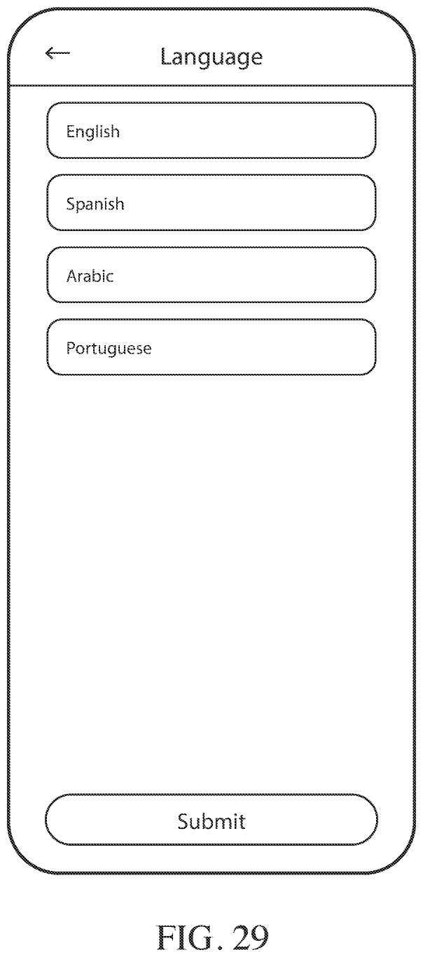

FIG. 29 is a diagram showing an example language setting GUI to merit a user to select a preferred language (e.g., English, Spanish, Arabic, or Portuguese).

FIG. 30 is a diagram showing an example color theme selection GUI to permit a user to select a color theme for the application.

FIG. 31 is a diagram showing an example delete account dialog GUI, which permits a user to delete an account.

FIG. 32 is a diagram showing an example sign out dialog GUI, which permits a user to logout of the application.

FIG. 33 is a diagram showing an example photos and documents gallery GUI, which permits a user to view photos or documents that have been captured with the application.

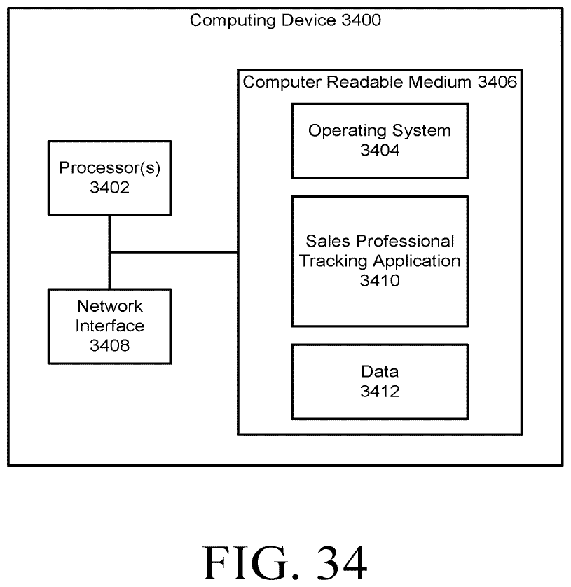

FIG. 34 is a diagram of an example computing device 3400 in accordance with at least one implementation. The computing device 3400 includes one or more processors 3402, nontransitory computer readable medium 3406 and network interface 3408. The computer readable medium 3406 can include an operating system 3404, an application 3410 for sales professional goal setting, tracking, and motivation and a data section 3412 (e.g., for storing sales goals, prospect information, completed sale information, commissions, contract information, etc.).

In operation, the processor 3402 may execute the application 3410 stored in the computer readable medium 3406. The application 3410 can include software instructions that, when executed by the processor, cause the processor to perform operations for sales professional goal setting, tracking, and motivation (e.g., performing associated functions described above in conjunction with the graphical user interface examples).

The application program 3410 can operate in conjunction with the data section 3412 and the operating system 3404.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for sales professional goal setting, tracking, and motivation.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A method comprising:
receiving sales contract information;
programmatically determining one or more monthly sales parameters;
programmatically determining one or more weekly sales parameters;
updating a graphical user interface with one or more of the one or more monthly sales parameters or the weekly sales parameters.
